(19) United States
(12) Patent Application Publication
(10) Pub. No.: US 2004/0147299 A1
(43) Pub. Date: Jul. 29, 2004

(54) Multiplayer interactive video gaming device

(76) Inventors: Michael A. Morris, Huntsville, AL (US); Douglas K. Morris, Huntsville, AL (US); Julian J. Kennedy, Longs, SC (US)

Correspondence Address: William A. Blake, Jones, Tullar & Cooper, P.C., Eads Station, P.O. Box 2266, Arlington, VA, 22202, US

(21) Appl. No.: 10/754,598

(22) Filed: Jan. 12, 2004

Related U.S. Application Data
(63) Continuation of application No. 09/901,135, filed on Jul. 10, 2001, now abandoned.
Application No. 09/901,135 is a continuation of application No. 08/885,276, filed on Jun. 30, 1997, now abandoned.

(51) Int. Cl. G06F 17/00

(52) U.S. Cl. 463/1

(57) ABSTRACT

A multiplayer interactive video gaming device is provided. The device includes a computer workstation assembly, at least one player station, and an interface assembly in operative communication with at least one data port of the computer workstation assembly and configured to receive player input messages from a plurality of the player stations and to output the player input messages to the computer workstation assembly by one or more of the at least one data ports. The interface assembly is operably associated with the at least one player station to route the player input messages from the at least one player station to the computer workstation assembly according to a predetermined protocol so that player input messages generated from simultaneous activation of a plurality of input devices are output to the computer workstation assembly without information loss.

### CROSS REFERENCE TO RELATED APPLICATIONS

This application is a continuation of U.S. application Ser. No. 09/901,135 filed Jul. 10, 2001, which is a continuation of U.S. application Ser. No. 08/885,276 filed Jun. 30, 1997, now abandoned.

### BACKGROUND OF THE INVENTION

The present invention relates to video gaming systems and, more particularly, to improvements in a video gaming machine that permit a plurality of players to simultaneously participate in a game.

Many video gaming machines are configured for single players. For example, a video blackjack or poker game machine may have one player station from which a player participates in an independent game executed by the machine's game processor. While popular, such games do not provide the group interaction found in live casino games.

Moreover, single player games are often located in establishments frequented by groups of customers and thus may be unattractive to customers not wishing to separate from their companions.

Video gaming machines typically include a cabinet housing at least a player station, a game processor assembly and a video monitor. The player stations include at least one input device by which a player inputs commands to the game processor. Generally, these input devices are push-buttons that, when depressed and/or released, trigger switches that send a signal to the game processor. However, any suitable input device, for example a joystick or touch screen, may be utilized. The player station also typically includes a currency acceptor by which a player deposits coins or paper currency for betting or for paying a fee to play the game. The currency acceptor is often, but is not necessarily, located proximate the input devices.

The game processor assembly is, generally, a computer assembly including an integrated circuit computer device that executes a video gaming program responsively to the commands input by the player at the player station. Often, this processor is a device which is custom programmed to execute only the video gaming program or related functions. The device may be mounted on a custom built circuit board that may include various peripheral devices as needed or desired. The circuit board is constructed specifically to operate in conjunction with the video gaming machine and is typically capable of receiving the input signals directly from each input device.

Multiplayer video games are known which utilize custom circuitry. Development and manufacture of systems including custom circuitry may, however, be expensive, particularly in the early stages. Thus, some gaming programs are developed on conventional personal computers. These devices employ components such as a central processing unit (CPU), memory, and an input/output system. The CPU is an integrated circuit “chip” that can perform a multitude of operations. The input/output system manages data handling among the CPU and other internal or external components. Thus, the personal computer is a general purpose computer, as opposed to single-program “embedded” systems, which may include a dedicated processor device mounted on a printed circuit board and configured to perform a single function. Personal computers are, typically, relatively small devices, for example as opposed to main frame computers. A personal computer assembly may be a board including a processor and an input/output system. It may also include a cabinet and/or various external and internal components, as should be understood in this art.

Because it is a multipurpose device, the personal computer assembly typically has no permanent input or output device having direct communication to the circuit board or, if there is more than on board, to the main circuit board. Instead, data is conveyed between input and output devices and the input/output system by data ports. These ports may have predetermined uses, for example to receive input from a keyboard or a mouse or to direct output to a printer or monitor. Personal computers also often include expansion slots for additional circuit boards which may, in turn, include their own data ports.

Computer software games are known which dedicate certain keys on a keyboard to individual players. However, a keyboard is inadequate for a video gaming machine, for example because of its physical awkwardness, its tendancy to detract from game realism, and its lack of a mechanism to receive currency for wagers or game fees. Additionally, keyboards are generally unable to accept simultaneous inputs from a plurality of keys.

Video gaming machines employing personal computer components without the addition of custom circuit boards or ports include means for conveying player input data to the CPU through existing components. However, multiplayer games include a relatively greater number of input devices, such as push-buttons, and, consequently, include a correspondingly greater number of communication lines than required for a single player game. Because the existing input ports in a typical computer configuration are inadequate to directly accommodate these communication lines, an interface system coordinates data transfer between the player stations and the data port(s). For example, multiplayer interactive video gaming machines are known that, applicants believe, employ a network arrangement. Players play individual games from individual player stations, each having a keypad, a personal computer circuit board, and a monitor. In a blackjack game, for example, input from the keypads is conveyed to the player station circuit board, which may execute the individual player blackjack game responsively to this input data and data relating to the dealer's hand provided by a central file server computer. The server computer may execute the entire game, with the player station computers operating the player station input and output devices responsively to the server computer.

### OBJECTS AND SUMMARY OF THE INVENTION

The present invention recognizes and addresses disadvantages of prior art construction and methods.

Accordingly, it is an object of the present invention to provide an improved multiplayer interactive video gaming device having a plurality of independent player stations and utilizing personal computer hardware.

More particularly, it is an object to the present invention to provide such a gaming device incorporating an improved interface assembly.

It is also an object of the present invention to provide an improved interface assembly capable of simultaneously processing multiplayer input messages.

Some of these objects are achieved by a multiplayer interactive video gaming device comprising a computer workstation assembly including an input/output system and at least one data port, the workstation assembly including a game processor device configured to receive input signals by the input/output system from one or more of the at least one data ports and to execute a video gaming program responsively to the input signals. The device includes at least one player station including at least one data input device and configured to output player input messages in response to activation of the the at least one data input device. The device includes an interface assembly in operative communication with the one or more at least one data port and configured to receive the player input messages from a plurality of the player stations and to output the player input messages to the computer workstation assembly by the one or more at least one data port. The interface assemby and the at least one player station are operably associated with each other to route the player input messages from the at least one player station to the computer workstation assembly according to a predetermined protocol so that player input messages generated from simultaneous activation of a plurality of input devices are output to the computer workstation assembly without information loss.

In a preferred embodiment, the system uses a single command entry port to service the player stations in such a fashion that all player station input devices are serviced in a prioritized manner that may be arbitrarily defined. All inputs are formatted into messages and queued so that no information is lost when multiple simultaneous inputs occur.

Preferably, a specialized input device processor is used that services each player station. A variety of input devices, for example joysticks, keypads, buttons, currency acceptors, coin/token acceptors, etc. may be attached. Each player station processor is designed to accept inputs, formulate messages regarding each input, and transmit those messages to a message concentrator. The player stations may communicate with the message concentrator directly, for example in a “star” arrangement, indirectly, for example in a “daisy-chain” configuration, or through a mixture of the two. The message concentrator acts as a buffer for incoming messages from a plurality of player stations which may be locally or remotely connected. The concentrator prioritizes the passing of messages to a workstation using a suitable algorithm, for example round robin, first-in first-out, rotating priority, random priority, etc. The queues on the message concentrator buffer all incoming messages and prevent the loss of input data in situations where multiple messages arrive simultaneously. The speed of message transfer allows the message concentrator processor to support multiple simultaneous input messages. Because most or all input messages may be directed to the workstation through a single input port, the concentrator queues input messages, in some prioritized fashion, into an output queue connected to this port. Thus, no messages are lost, and the workstation receives most or all messages through a single input port, providing increased security and testability.

The message concentrator extends the workstation input port into multiple input ports while allowing the workstation to communicate with the player stations through a single output port. Thus, in a star arrangement, the message concentrator acts as a game network hub managing both input and output messages. In a daisy-chain arrangement, the concentrator is the head of the chain which directs messages to the workstation input port.

The interface assembly is operably associated with the player stations to route the player input messages to the game computer. In the star arrangement of an exemplary video blackjack game, for example, the player stations output the input messages directly to a concentrator. Each player station generates and outputs player input messages according to a predetermined protocol so that input messages resulting from simultaneous button activations at that player station are routed to the concentrator without information loss. The concentrator, in turn, receives the player input messages from a plurality of player stations and routes these messages to the game computer according to its protocol so that player input messages simultaneously received from a plurality of player stations are routed to the game computer without information loss. Thus, the concentrator and the player stations are operably associated with each other to route the input messages to the game computer so that player input messages generated from simultaneous activation of a plurality of buttons are output to the game computer without information loss.

In an exemplary daisy-chain arrangement of the same game, only one player station communicates directly with the concentrator. The remaining player stations are linked downstream from the concentrator in tandem from the first player station. As in the star arrangement, each player station generates and outputs player input messages according its protocol so that input messages resulting from simultaneous button activations at that player station are output from the player station without information loss. The player stations in this arrangement, however, include an additional serial port to receive player input messages from downstream player stations. These downstream player input messages are received by a player station and passed on to the next upstream player station or, if the player station is the first in line, the concentrator without interfering with the processing and routing of its own input messages. Thus, the concentrator and the player stations are operably associated with each other to route the input messages to the game computer so that player input messages generated from simultaneous activation of a plurality of buttons are output to the game computer without information loss.

The accompanying drawings, which are incorporated in and constitute a part of this specification, illustrate one embodiment of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a preferred embodiment of a multiplayer interactive video gaming device constructed in accordance with the present invention;

FIG. 2 is a block diagram illustration of a preferred embodiment of a player station used in a multiplayer interactive video gaming device constructed in accordance with the present invention;

FIG. 3 is a block diagram illustration of a preferred embodiment of an interface device used in a multiplayer interactive video gaming device constructed in accordance with the present invention;

FIG. 4 is a schematic diagram of a preferred embodiment of player station hardware used in a multiplayer interactive video gaming device constructed in accordance with the present invention;

FIG. 5 is a schematic illustration of a preferred embodiment of an interface device used in a multiplayer interactive video gaming device constructed in accordance with the present invention;

FIG. 6 is a partial schematic diagram of a preferred embodiment of a multiplayer interactive video gaming device constructed in accordance with the present invention;

FIG. 7 is a block diagram illustration of a preferred embodiment of the present invention in a daisy-chain arrangement; and

FIG. 8 is a block diagram illustration of a preferred embodiment of a station architecture used in a multiplayer interactive video gaming device constructed in accordance with the present invention in a daisy-chain arrangement.

Repeat use of reference characters in the present specification and drawings is intended to represent same or analogous features or elements of the invention.

DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

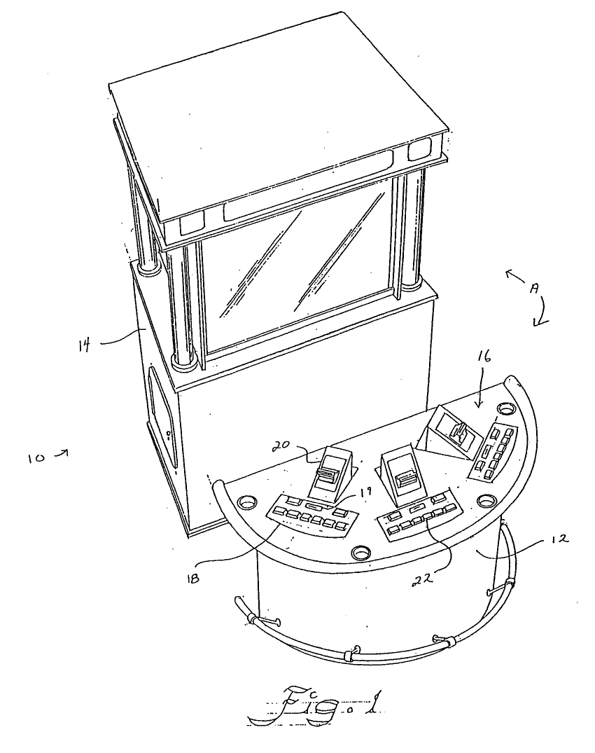

The present invention is concerned with an improved multiplayer interactive video gaming device. Accordingly, FIG. 1 depicts a presently preferred embodiment of a multiplayer interactive video gaming device, indicated generally at 10. A cabinet A is divided into player portion 12 and a display portion 14. Display portion 14 and player station 12 are attached by a connection piece (not visible in the view shown) through which communication and power lines may be passed. It should be understood, however, that various cabinet configurations are possible. For instance, the player portion and the display portion may be unitarily constructed. A multiplayer video gaming device is described in U.S. patent application Ser. No. 08/540,328, the entire disclosure of which is incorporated by reference herein.

Player portion 12 is constructed to simulate a casino blackjack game table. Three player stations 16 are disposed on the top counter surface of player portion 12. Each player station 16 includes a keypad 18 and a currency acceptor 20. Each keypad 18 includes a plurality of input keys 22 through which players participate in the blackjack game. In the embodiment shown, the currency acceptor is a bill acceptor configured to receive bills of various denominations. The currency acceptor could also accept coins.

In this embodiment, each keypad 18 includes a first row of five, and a second of two, input keys 22. It should be understood by those ordinary skill in this art that the use, number, and arrangement of such keys can depend upon the nature of the video gaming program operated within the present invention. For example, a blackjack game may require the use of different keys for different purposes than a poker game. Bill acceptor 20 accepts bills for betting and/or game fee purposes.

A ticket dispenser 19 is mounted at each player station. Players may “cash out” at any time by inputting a proper command at their player station. Upon cashing out, a printer mounted within the cabinet prints a redeemable ticket indicating the player's winnings via ticket dispenser 19.

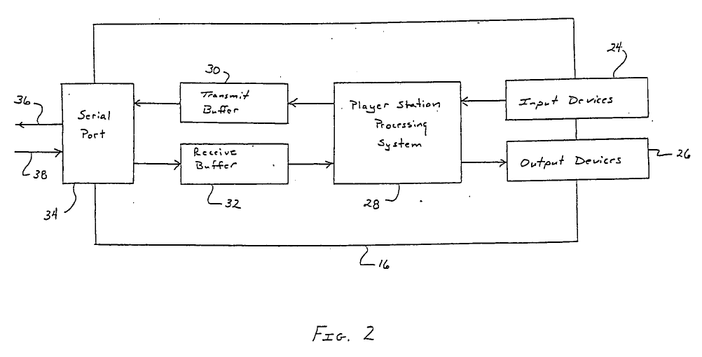

A functional illustration of a player station 16 is provided in FIG. 2. As indicated above, the player station includes a plurality of input devices 24, which may include, for example, player input buttons 22 and currency acceptor devices such as bill acceptors 20 (FIG. 1). Player station 16 also includes output devices 26, which may include lamps, digital output displays, token dispensers, meters and/or currency return devices such as ticket dispensers 19 (FIG. 1), which output currency to players in the form of redeemable tickets. Currency acceptor and return devices may include magnetic card readers/writers and IC card readers/writers to accept and/or pay out currency electronically.

Player input messages are transferred from the player stations to a workstation including a game processor running the video gaming program. The workstation may include a data port, such as a serial port or a keyboard port, an input/output system, and a suitable communication arrangement communicating with a remote game computer. Accordingly, a workstation assembly may comprise a local computer, to receive input from a plurality of player stations, and a remote computer, to receive input signals from the local computer and execute the game program responsively to such signals. The local and remote computers may communicate through any suitable arrangement, for example telephone systems or local area network systems. The remote computer's game processor thereby receives input signals from the data port of the local computer. In this arrangement, a single game processor may operate a plurality of remote player station groups. Alternatively, a workstation assembly may comprise a remote computer and a communications system, such as a telephone system or local area network system, through which multiple player stations communicate with the remote computer. Thus, a plurality of single-player stations separated by relatively long distances may participate in a single-player or multi-player game operated by the remote computer. Additionally, however, the workstation may be a personal computer assembly including an input/output system, one or more data ports and a game processor device in a local unit. Although a personal computer assembly is the workstation type most often discussed herein, it should be understood that this is for exemplary purposes and that all workstation configurations, provided they are suitable for a given embodiment, are within the scope and spirit of the present invention. The remote computer in any of these arrangements may operate a progressive jackpot feature in which all communicating player stations may participate.

The player input message is the information input at the player station, for example by player activation of a button or bill acceptor or by system activation of a maintenance condition at a token dispenser, and conveyed to the personal computer through the player station and interface assembly equipment. During the transmission, the message may take a variety of forms. For example, in a preferred embodiment as illustrated in the figures, one type of player input message may be input by pressing a button 22 (FIG. 1). As discussed in more detail below, this delivers a signal, for example a pulse, to the player station control mechanism, which identifies the pulse and selects an appropriate ASCII input code. The player station outputs the ASCII input code to the interface assembly, where the interface assembly control mechanism converts the input code to a scan code for transmission to the personal computer.

Another type of player input message may be input by activating a bill acceptor. The bill acceptors may deliver input signals to the player station control mechanism in a variety of forms, for example as a series of pulses or as a digital word. It should be understood that all such configurations are included within the scope and spirit of the present invention.

The internal components of player station 16 are illustrated functionally in FIG. 2 by player station processing system 28, transmitting buffer 30 and receiving buffer 32. In a preferred embodiment, processing system 28 receives data directly from input devices 24. If many input devices are employed on a player station, however, it is possible to create a row/column matrix for routing data via multiplexing to the processing system, as should be understood in this art.

In operation, if the processing system 28 detects, for example, a falling pulse indicating that a particular button has been pressed, the processing system associates the pressing of that button with an appropriate code. In a present embodiment, the code is a four character message. The first character indicates that the message is beginning. The second character indicates the message type, which identifies the message as, for example, a button message or a dollar bill acceptor message. The third character provides the message information, for example that button number three has been pressed. The fourth character indicates the end of a message. The coding prevents information loss and/or message scrambling when the messages are queued or dequeued. A more detailed description of the message structure is provided in the Appendix. It should be understood, however, that this message structure is provided for exemplary purposes only. For example, there may be changes to certain delimiting characteristics and address characteristics to avoid conflicts with other devices which may be used in the system. For example, in one embodiment, the lead, or start, character has been changed from “control-A” to “control-V.”

After creation of the appropriate code, the message is stored in transmitting buffer 30. A serial port 34 is provided on player station 16 to output the data stored in buffer 30. The serial port converts data from a parallel format to a serial format to transmit and converts from a serial format to a parallel format to receive. Status signals indicate whether the transmitter is available (empty) and whether the receiver contains data (full). Two data lines, transmit line 36 and receive line 38, are connected to serial port 34. Processing system 28 monitors a status signal associated with transmit line 36. When a “transmitter empty” condition is indicated, the next message character in transmit buffer 30 is transmitted through serial port 34 along transmit line 558 36.

Data received from receive line 38 through serial port 34 is stored in receive buffer 32. Processing system 28 receives messages from buffer 32 and acts according to instructions provided thereby. Thus, processing system 28 may be caused to illuminate lamps at the player station, dispense coins through a token dispenser, print a cash out ticket, or other desired functions.

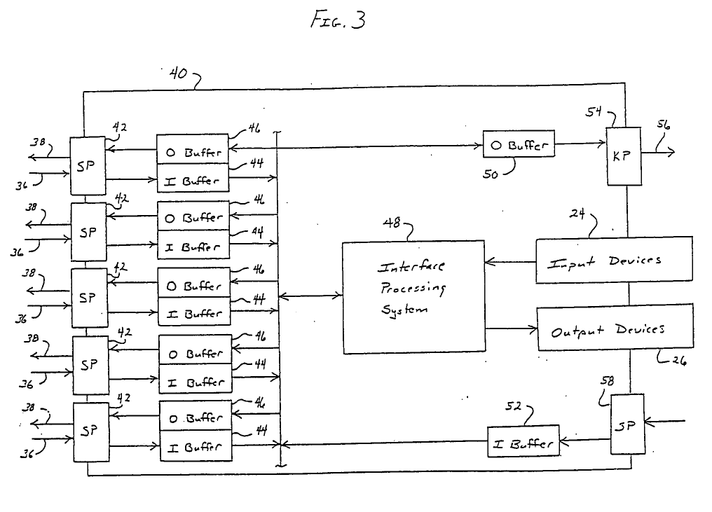

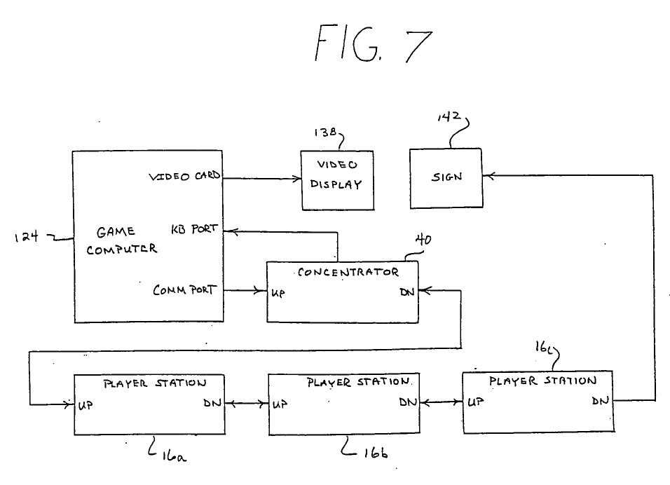

In a star arrangement, each player station 16 communicates with a central interface device for transferring player input messages to the game computer. As illustrated in FIG. 3, each player station communicates by its respective transmit line 36 and receive line 38 with the interface device 40 via serial ports 42. Five player stations may be employed within the construction illustrated in FIG. 3, although less than five, for example three, may be used. In a daisy-chain arrangement as illustrated in FIG. 7, the player stations may be connected in tandem so that messages move in and out of successive, player stations until reaching the central interface device. Each player station includes an additional serial port and buffer, and each player station processing system generates new messages to the next player station to pass on a message received from a prior player station.

Referring again to FIG. 3, interface 40 includes receive buffers 44 and transmit buffers 46 corresponding to each player station. An interface processing system 48 controls the transfer of information between the receive buffers 44 and the interface output buffer 50 and between the interface input buffer 52 and the transmit buffers 46. When processing system 48 receives an incoming message from a receive buffer 44, the processing system converts [symbol] 48, illustrated in FIGS. 2 and 3, and the input and output buffer systems, without loss of information. Thus, if two players press input buttons at their respective player stations simultaneously, both input messages will be received by the game computer.

Commands from the game computer to player station output devices are transmitted to interface input buffer 52 via interface device serial port 58. Processing system 48 receives messages from buffer 52, determines to which player station the command should be forwarded, and stores the command in the appropriate output buffer 46 for transmission to the player station via the corresponding serial port 42. If the system is daisy-chained, only one transmit buffer is required. As each message is received by a player station, it is relayed to and examined by the next player station. If the message is found to be for this player station, that station's processing system performs the requested action.

Processing system 48 may also communicate directly with input devices 24 and output devices 26. These may include the same input and output devices discussed above with respect to the player stations. That is, the input and output devices of a single player station may be directly connected to interface device 40 without a player station processing system 28 and buffers 30 and 32 (FIG. 2) that are associated with the individual multiple player stations. Thus, the game computer/interface assembly may be used with player stations of single player games which do not have such processing systems or buffers. Accordingly, the game computer/interface assembly may be used interchangeably with a multiplayer or a single player configuration. Video gaming machines may be constructed with removable player station units so that the game may be converted between a multiplayer game and a single player game simply by interchanging the player station unit or units. Provision may be made to reprogram or,convert the game computer to a new-or previously stored program to enable operation of the new game.

In another preferred embodiment, the interface device may be physically embodied on a player station so that this player station communicates with the game computer through the keyboard port. Other player stations output messages to the game computer through this first player station to avoid loss of information. Player station units may be linked to the first player station in a star or daisy-chain arrangement and may be added or removed to achieve a desired number of player stations.

As described above, processing system 48 receives incoming codes from the player stations and converts the codes to scan codes which the operating system on the game computer will recognize. Since there are a finite number of messages which will come from any player station, a unique scan code may be assigned to each particular message from each player station. This may be accomplished, for example, by converting player station messages into keyboard scan codes. Thus, in a preferred embodiment, each player station includes similar input devices in a similar arrangement and outputs the same messages for the same corresponding devices. Processing system 48 assigns scan codes based upon the player station message and the player station itself. Thus, the assignment of the scan code depends upon the particular message and the particular player station from which the message is received.

It should be understood, however, that various suitable configurations are possible. For example, while in a preferred embodiment the player station processing systems assign ASCII codes as the player station messages, various coding processes may be employed. Thus, for example, scan codes could be assigned at the individual player stations, eliminating the need to make the assignment at the interface device.

In the illustrated local unit embodiment, the game computer is, preferably, an IBM PC/AT compatible personal computer. Thus, the scan codes assigned by processing system 48 are compatible with the operating system provided on those computers. The operating system is configured to receive the scan codes from the computer keyboard port and to use those codes for operating system functions and/or higher level functions. In particular, the IBM PC AT compatible computers may receive the scan codes and convert them to ASCII codes, which may be output to a screen and which may be used in commercial or custom software, including the gaming program.

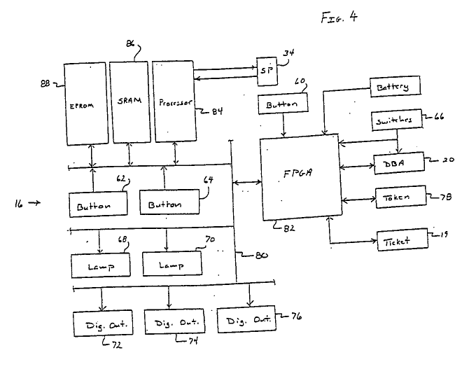

A schematic illustration of a player station is provided in FIG. 4. A plurality of buttons are indicated by button groups 60, 62 and 64. Each button group may include up to eight individual input buttons 22 (FIG. 1), for a total of 24 input buttons. A bill acceptor 20 is controlled by a series of dip switches 66, which may be used to program the bill acceptor to, for example, accept certain bill denominations and/or select serial or pulse mode operation.

Output devices includes lamp groups 68 and 70 and digital output groups 72, 74 and 76. As with the button groups, each lamp group and each digital output group includes eight lamps and eight digital output devices, respectively. It should be understood, however, that all of the available input and output devices may not necessarily be employed in a particular game; the illustrated construction merely indicates that they are available. Other output devices include token dispenser 78 and ticket dispenser 19.

Data is transmitted to or from these input and output devices on 8-bit data bus 80 and is controlled by field programmable gate array 82. Gate array 82 may be, for example, a Xilinx XC3042 or XC5202 gate array or other suitable device.

Data transfer from the player station is controlled by a processor 84 which, in one preferred embodiment, is an 8051-compatible microcomputer having one or two on-chip serial ports. It should be understood that other processing devices may be used, for example those including on-board EPROMS. Although processor 84 includes a certain amount of memory, SRAM 86 provides additional storage. Together, this memory serves as the player station buffers. EPROM 86 provides storage for the programming for processor. 84 and the look-up tables by which input codes may be assigned to particular input signals. A PAL (not shown), for example a 20V8 PAL, is provided to decode the microprocessor address range into three ranges—EPROM, processor and input/output devices, including the gate array.

In operation, processor 84 controls gate array 82 to input and output data to and from the input devices and output devices. An internal logic signal of the gate array 82 causes gate array 82 to send an interrupt signal to processor 84 every 25 milliseconds. In response to this interrupt command, processor 84 orders gate array 82 to sequentially place the contents of the data registers of the respective button groups on data bus 80. Thus, if a player presses one of the buttons in button group 62, the corresponding position in the button group 62 register changes state. Following the next 25 millisecond interrupt signal from gate array 82, processor 84 causes gate array 82 to connect the register of button group 62, in order among the other button groups, to common bus 80. In the embodiment depicted in FIG. 4, button group 62 may include up to eight buttons so that each button position of the button group 62 register may correspond to a data line on eight bit bus 80. Thus, of the eight data lines input to processor 84 from bus 80, seven are at a normal state while one has changed state due to the pressed button. Because processor 84 causes gate array 82 to connect the button group registers to the common bus in a certain order, processor 84 knows which button group is connected to the common bus at any time. In this manner, the processor identifies the particular button group from which it receives an input message. The particular button or buttons within the button group is determined by the line or lines on common bus 80 that have changed state.

As indicated in FIG. 4, button group 60 communicates with processor 84 indirectly, through gate array 82. The buttons of button group 60 communicate directly with the gate array, which acts as the register for button group 60.

Once processor 84 determines that a particular button in a particular button group has been pressed, it generates an ASCII code corresponding to that particular button. This can be done, for example, either by an algorithm that is part of the processor 84 program or according to a lookup table stored in EPROM 88. Once the code is established, it is translated into a message which is stored in a transmit buffer in SRAM 86 until processor 84 determines that the serial transmitter (not shown) of serial port 34 is free. When the output line is free of data, processor 84 outputs the stored ASCII codes from SRAM 86 through serial port 34 to the output data line.

If two or more buttons in a button group are simultaneously pressed, processor 84 converts each signal into a corresponding ASCII code and stores signals in SRAM 86 according to a predetermined order, for example depending upon the data line over which they were received. The corresponding messages are output through serial port 34 in the order in which they are stored in SRAM 86. By this protocol, simultaneous button activations are accommodated without information loss.

This assumes, however, that the activation of all the buttons represents information—data that the game program should receive to operate properly. In some games certain buttons, for example “Bet” or “Hit” buttons, are inappropriate at certain times. While the game program itself may be configured to ignore the data resulting from these button activations once such data is received, the program may control processors 84 and 96 to mask these buttons so that the data is not forwarded to the game computer. Additionally, the processors may be programmed to recognize one or more button activations, and not recognize one or more others, when buttons are simultaneously activated where the latter buttons may always be ignored in favor of the former buttons. In any event, the video gaming device may be configured to ignore button activations which do not represent information while maintaining the ability to process those simultaneous button activations that do.

Processor 84 may also receive inputs from bill acceptor 20, token dispenser 78 and/or ticket dispenser 19. The inputs from bill acceptor 20 primarily relate to the amount of currency input by the player. Inputs from the token dispenser generally concern errors, for example that there are insufficient tokens in the dispenser. Inputs from ticket dispenser 19 may include error signals but may also include signals indicating, for example, that a ticket has been printed and dispensed.

These devices are programmed to output an appropriate message to gate array 82 in a predetermined format, for example ASCII hexadecimal. Upon receipt of such a message, gate array 82 stores a digital signal indicating the origin of the message and sends a second interrupt signal to processor 84. Upon receipt of this type of interrupt signal, processor 84 reads the identifying signal stored in gate array 82 and causes gate array 82 to pass the input from that particular device to common bus 80 where it is read by processor 84. Processor 84 converts these messages, either by a program algorithm or by a lookup table, to an ASCII code which is output by serial port 34.

Data commands to a player station are received through serial port 34 by processor 84, which stores the command in SRAM 86. The command will identify a particular output device, for example ticket dispenser 19 or a lamp in lamp group 70. Assuming the latter, processor 84 causes gate array 82 to connect processor 84 to lamp group 70, at which time processor 84 writes appropriate data on bus 80 to drive the particular lamp in lamp group 70 while preserving the previous state of the other lamps in the group. Instructions to bill acceptor 20, token dispenser 78 and ticket dispenser 19 are generally in the form of digital words which are downloaded to the particular devices through gate array 82. These output devices are configured to receive this information and act accordingly. The particular construction and configuration of these devices are well known in the art and need not be described herein.

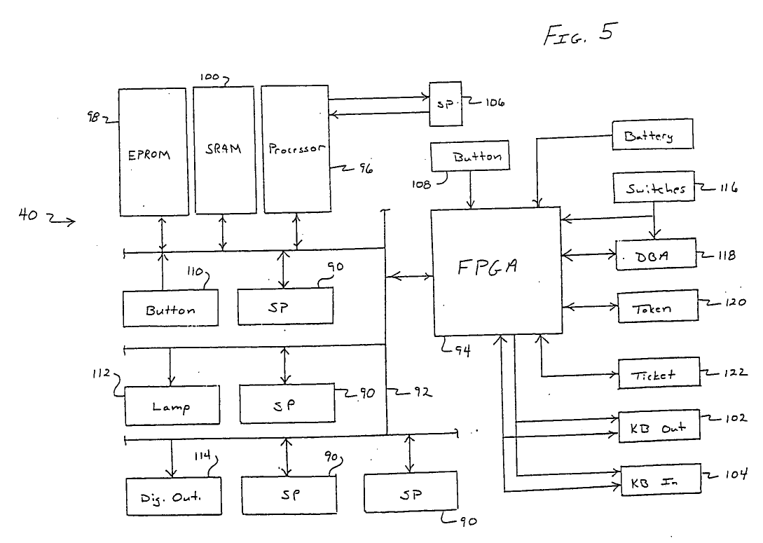

Player stations 16 communicate with the game computer through a concentrator board 40 (FIG. 3). A schematic illustration of concentrator board 40 is provided in FIG. 5. In the star arrangement, each player station communicates with concentrator board 40 from the player station's serial port 34 (FIG. 4) to a serial port on the concentrator board. Four serial port groups 90 are provided on the concentrator board. Each serial port group 90 includes four serial ports, each having an input line and output line. Thus, each serial port group has eight data lines in communication with an eight bit data bus 92. Accordingly, in the configuration illustrated in FIG. 5, sixteen player stations may be connected to concentrator board 40, although in preferred embodiments three or five player stations are employed.

Field programmable gate array 94 controls communication of data along bus 92 between a processor 96 and the ports and devices communicating with the bus. Any suitable processing device, for example an 8051-compatible microcomputer, may be used. Gate array 94, EPROM 98 and SRAM 100 may include the same or similar components as the corresponding components on the player stations.

EPROM 98 stores the program executed by processor 96. Processor 96 may include its own internal memory for use as buffers. Preferably, however, SRAM 100 is included to provide additional memory.

A player input message from a particular player station is received at a serial port, which communicates with that player station, in one of the serial port groups 90, where it is stored in the serial port group register. Upon receipt of an interrupt signal periodically sent by gate array 94, processor 96 instructs gate array 94 to sequentially connect the register of each serial port group 90 to the eight data lines of common bus 92. In this manner, processor 96 is able to determine from which serial port, and therefore from which player station, it receives data. Processor 96 stores the incoming data either in its internal memory or in SRAM 100.

As discussed above, the incoming messages are in the form of ASCII codes. Processor 96, either by computer program algorithm or by a look up table stored in EPROM 98, assigns a scan code appropriate for the particular ASCII character from the particular player station. The scan code is then stored in SRAM 100.

Processor 96 monitors the status of keyboard output port 102 by gate array 94. If the output data line is clear, processor 96 outputs the stored scan code from SRAM 100 over bus 92 to gate array 94 to keyboard output port 102. Keyboard output port 102 communicates with the game processor via a personal computer keyboard port.

Data may be downloaded from the game computer via a keyboard input port 104 or serial port 106. If data is downloaded to keyboard input port 104, gate array 94 sends a second interrupt signal to processor 96, [symbol] [symbol] to the computer as keyboard scan codes as described above.

The tandemly-linked player stations illustrated in FIG. 7 may be configured as shown in FIG. 4 with the use of a second serial port 34 to processor 84. Thus, one of the serial ports 34 is used as the up port, and the other is used as the down port. The up ports and down ports are bidirectional. Thus, assuming player station 16 illustrated in FIG. 4 is player station 16b illustrated in FIG. 7, the up serial port 34 receives command messages from, and outputs input messages to, the down port of player station 16a, while the down port 34 receives input messages from, and outputs command messages to, the up port of player station 16c. Command messages received by up port 34 are stored in SRAM 86. The command message includes an identifier indicating for which player station it is intended. Processor 84 reads the identifier and, if the command message is intended from player station 16b, acts upon the message as described above. If, however, the command message is intended for player station 16c, processor 84 directs the message to down port 34 for output to player station 16c.

Player station 16b receives input messages from player station 16c through down port 34 and stores these messages in SRAM 86. Since these messages are intended for the game computer, processor 84 directs these messages to player station 16a through up port 34. The input messages from player station 16b are also passed to player station 16a through the up port.

Processor 84 may simultaneously receive and store messages from its dual serial ports 34 (the up and down ports). If a message is to be passed through the player station, processor 84 may simply direct the message from one serial port to the other, or it may place the message on SRAM 86 for output at a later time. In any event, a player station may process command and input messages received from external sources while generating its own input messages without losing information even if, for example, a command message and an input message are received at the same time a button is pressed at the player station. Thus, from the perspective of player station 16b, the interface between it and game computer 124 is concentrator 40 and player station 16a.

A receive-only serial device, such as sign 142, may be connected on the end of the chain. The network messaging protocols may be designed to allow other devices to be connected without mutual interference. That is, the message formatting for the player station network may be different than that used by the sign, and the two protocols may coexist without interference.

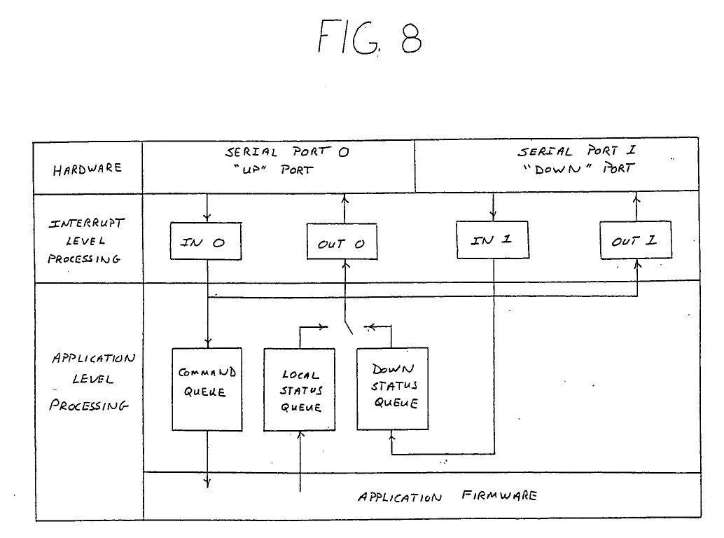

FIG. 8 illustrates one preferred player station network architecture. There are three distinct processing levels for handling network traffic. At the hardware level, two standard on-chip serial communications ports handle all data serialization and deserialization. At the interrupt level, the on-board processor handles characters received from or sent to the serial ports. At the interrupt level, the processor manages two receive buffers and two transmit buffers. At the applications level, where all of the application's code has the same execution priority, the processor queues and dequeues messages in three queues. An input queue holds parsed command messages for processing by the application firmware. Two output queues hold complete input messages from the player station to be passed, using an arbitrary prioritization scheme, to the up port's output buffer. Round-robin prioritization, for example, may be used to empty the output queues.

The above description illustrates both a star and daisy-chain arrangement. The concentrator and player stations support either topology. While the concentrator arrangement may exhibit superior performance, the daisy-chain arrangement is, generally, less expensive. The choice among star, daisy-chain and a combination of the two arrangements will depend upon the requirements of a specific application.

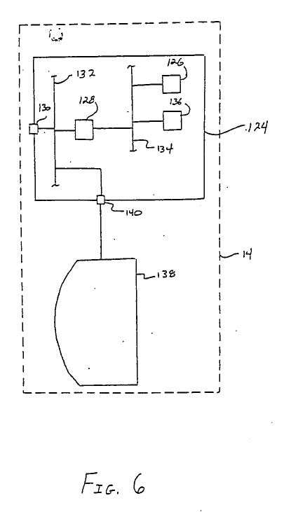

Referring now to FIG. 6, personal computer assembly 124 houses a game processor such as a CPU 126, for example a PENTIUM processor, for executing a blackjack gaming program responsively to the player input messages from player stations 16 (FIG. 4). An input/output system such as a BIOS 128 receives the input messages from concentrator board keyboard output port 102 (FIG. 5) by keyboard port 130 and bus 132. BIOS 128 outputs a signal to CPU 126 over a bus 134. As should be understood by those of ordinary skill in the art, BIOS 128 may decode or encode signals received by CPU 126 depending upon, for example, the configuration of the personal computer assembly.

Moreover, a variety of circuitry configurations are possible within the range of personal computers. For example, a variety of input/output, memory (for example RAM 136), buses, and other devices may be arranged in various suitable configurations. Furthermore, various methods may be employed utilizing such devices and configurations in communicating information between keyboard port 130, or other suitable data input port, and CPU 126. It should be understood that all suitable such personal computer configurations may be employed in accordance with the present invention.

As it executes a video card gaming program, CPU 126 outputs video display signals to a monitor 138 via a parallel port 140. The video card gaming program executed by CPU 126 permits interactive participation by a plurality of players at player stations 16 (FIG. 1).

The video card gaming program is preferably written in an “event-driven” language such a Visual Basic or Visual C. An event-driven program performs operations responsively to “events,” such as the depression of a push button that, in turn, causes BIOS 128 to output a signal to CPU 126. As should be understood by those of ordinary skill in this art, personal computers are generally equipped with operating systems which are configured to manage communication between the personal computer and the software programs. In particular, the operating system is configured to recognize certain signals, for example scan codes received by the keyboard port and to convert such signals into predetermined codes, for example ASCII codes, which may be utilized by the program. In a preferred embodiment, personal computer assembly 124 is an IBM-compatible system using a MSDOS-compatible operating system. The scan codes assigned by the concentrator board (FIG. 5) are converted by the operating system to ASCII codes which are utilized in operation of the video card gaming program.

Although a variety of card gaming programs may be utilized in accordance with the present invention, in one presently preferred embodiment CPU 126 is configured to execute a blackjack game wherein the gaming program generates a “dealer's” blackjack hand on monitor 138 that is visible to the players at the player stations. The players submit wagers, accept or reject card “hits,” and select game options via the keys at the player stations. The player's hands are displayed on monitor 138 along with the dealer's hand in a manner similar to the display of cards on a casino blackjack table. Various versions of the basic blackjack or “21” game are known and may be employed in accordance with the present invention.

Various types of metering devices may be employed within the system. For example, an “in” meter may be used to count the amount of money put into the gaming machine. The construction of such meters, which should be well understood in the industry, need not be described herein. Typically, however, the meter is a relatively simple counter which is incremented by pulses. The in meter may be implemented within the system as are various input/output devices illustrated in FIG. 4. Thus, one or more such meters may communicate with common bus 80 directly, like button group 64, or through gate array 82, like button group 60.

In operation, the game computer may receive data from a player station's bill acceptor 20 corresponding to an amount of currency accepted. The game program recognizes this amount and causes the game computer or processor 84 to output an appropriate number of pulses to the in meter so that the in meter properly increments, thereby recording the amount of money input at the player station. The number of pulses sent to the meter depends upon the denomination by which the meter is to count. For example, if the machine accepts currency in dollar, or greater, increments, the meter may increment for each dollar input at the machine or player station. Thus, if a player inputs a five dollar bill, the meter is incremented five times.

By controlling the meter through the game program, various types of bill acceptors may be used, for example those which output data by pulses or by digitally formatted signals. Various types of currency may be accepted, for example paper, coins or electronic media.

Other such meters may be attached within the system in a similar fashion for other purposes. For example, the game program may increment an “out” meter to record the amount of money cashed out at the machine or player station, for example through a coin or bill hopper, ticket dispenser or electronic output mechanism. The program may also increment a “credits played” meter, to record how much money is wagered at a player station, and a “credits won” meter, to record the amount of money returned to the player station as winnings. Additionally, switches may be provided at the game cabinet's main door through which the game hardware is accessed, and/or, for example, at one or more cash drawers, that change state upon opening or closing of the door or drawers. These switches may communicate with the game computer, as do other peripheral devices such as the buttons and lamps described above, so that the game computer is notified of the openings and/or closings. Upon notice of a door or drawer opening, the game computer may increment a meter installed for this purpose. Such an arrangement may serve a security purpose, since the game's owner or operator may monitor the meter to assure that the game has not been opened since the previous meter reading. It should therefore be apparent that various game “events” may be metered using the arrangement and construction of the present invention.

The meters may be employed in a variety of game configurations. For example, as described above, they may be used in conjunction with an interface assembly as described herein that facilitates communication between player stations and a workstation running the game. They may also be used, however, in arrangements without such an interface assembly, such as embedded systems or networked player stations not employing a common interface. In an embedded system, the meters can communicate with a dedicated processor on a printed circuit board directly, for example through direct wiring to the circuit board, or indirectly, for example through processors at the player stations. The dedicated processor can increment the meters appropriately as events, such as money in, money out, money wagered, money won and door openings or closings, occur. In the networked arrangement, the meters may be incremented by a server, either directly or through the player stations, or by player station processors.

As noted above, one or more meters may be employed to record data for each player station. Alternatively, in a multiplayer game, a group of meters may be used to record such data for the multiplayer game as a whole, rather than per player station. Such meters may be attached as peripheral devices to the concentrator board 40 (FIG. 5) or to one of the player stations. Furthermore, meter groups, whether for use with the gaming machine as a whole or with individual player stations, may be placed on their own boards. Such a board may include, for example, a memory device, a microprocessor and, possibly, an FPGA. Its construction and operation would be similar to that of the player station 16 arrangement illustrated in FIG. 4, but on a smaller scale. In a star arrangement, such a board could communicate with an interface processing system 48 by a serial port 42 (FIG. 3). In a daisy-chain arrangement, the meter board, or boards, may be linked with the player stations.

Moreover, the player stations themselves may be constructed by multiple such boards, each containing a certain group of input and/or output devices. Thus, a player station may have a board for its meters and a separate board for its buttons. In this manner, defective components may be replaced without requiring replacement of the entrire player station hardware. Further, a cabinet may be more easily reconfigured to play a different game which might require a different configuration of certain player station devices.

While preferred embodiments of the invention have been described above, it should be understood that any and all equivalent realizations of the present invention are included within the scope and spirit thereof. The embodiments depicted are presented by way of example only and are not intended as limitations upon the present invention. Thus, while particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

### APPENDIX

I. General Message Structure

The serial port messages to the various devices on the player stations are routed to the spare communications port of the game computer, an IBM-compatible personal computer. This appendix defines the general structures of the messages needed to control the various devices.

There are two types of serial port messages: output messages and input messages. The output messages are those sent from the game computer to the various devices. Input messages are those received by the game computer from the various devices. Not all devices necessarily respond to commands from the game computer.

1.1 Output Message Structure

The basic output message structure comprises a one character header, a one character address, a data field of unspecified length, and a single character terminator. The header and the terminator are the ASCII NULL character, 0x00. The address character identifies the player station to which the output message will be routed.

The data field comprises an unrestricted number of characters. The characters in the data field may include any ASCII codes other than the ASCII NULL code. Specific messages to a device will have a defined structure discussed below.

The general output message structure can be summarized as: NULL—address—data field—NULL.

Table one summarizes exemplary defined addresses. Either upper case or lower case characters may be used as the address character. The ‘*’ address character is used to broadcast the data field of an output message to all the player station control boards.

All messages are sent using the above-defined format. This applies to all defined messages even if it is possible to distinguish between messages having fixed length data fields. Because the ASCII NULL character is used for both the header and terminator of a message, it is possible to use the terminator of one message as the header for the next message. Thus, two consecutive ASCII NULLs are not required to separate messages.

TABLE 1
MESSAGE ADDRESSES

| Destination | Address |
|---|---|
| Player Station #1 | ‘A’ |
| Player Station #2 | ‘B’ |
| Player Station #3 | ‘C’ |
| Player Station #4 | ‘D’ |
| Player Station #5 | ‘E’ |
| All Player Stations | ‘*’ |
| Concentrator Board | ‘F’ |
| Printer | ‘P’ |
| Progressive Sign | ‘S’ |

1.2. Input Message Format

The basic input message structure comprises a one character header, a one character message type identifier, a one character address, a data field of unspecified length, and a single character terminator. The header and the terminator are the ASCII NULL character. The address character identifies to which board the messages will be sent. The message type identifier character is defined in Table 2. The data field comprises an unrestricted number of characters. The characters in the data field may comprise any ASCII codes other than the ASCII NULL code. Specific messages from a device will have a defined structure discussed below.

The general input message structure can be summarized as:

NULL—type—address—data field—NULL. Input messages use the same address identifier character as defined in Table 1.

TABLE 2
INPUT MESSAGE TYPE IDENTIFIERS

| Message Type | Identifier |
|---|---|
| Error | ‘?’ |
| Status | ‘!’ |
| Credit Entry | ‘$’ |
| Button Action | ‘@’ |

II. Output Messages: PLAYER/CONCENTRATOR

This section defines the output messages from the game computer that are processed by the player station control board (PLAYER) or the player station concentrator board (CONCENTRATOR). These two boards support many of the same functions and devices in common. However, the CONCENTRATOR also routes serial printer data streams to a serial printer which is not supported by the PLAYERs. Therefore, all the common messages are defined in subsection, and CONCENTRATOR-specific commands are defined in subsection.

2.1 Common Output Messages to PLAYER/CONCENTRATOR

The PLAYER and CONCENTRATOR boards support a common set of devices. Therefore, there is a common set of output messages between them. There are five common output messages:

2.1.1. Lamp/Relay Control Message

The lamp/relay control message controls the state of each lamp/relay driver pin. The PLAYER board has fourteen drivers. The CONCENTRATOR board has seven drivers. The driver pins are addressed sequentially from 1 to 14; the CONCENTRATOR drivers are addressed from 1 to 7. The lamp/relay control message takes two forms. The first allows each driver to be individually addressed and to be turned on or off. The second simultaneously addresses all the drivers and turns each on or off based on a four digit ASCII Hexadecimal code. Each bit represented in the ASCII Hex code turns on the lamp/rely if the bit is set to a logical 1 or turns off the lamp/relay if the bit is reset to a logical 0.

The data field format of the first lamp/relay control message formed is:

‘L’{h} {‘0’|‘1’}.

The ASCII Hexadecimal number {h} is the number of the lamp/relay driver to be controlled. The valid range of {h} is 1(‘1’) to 14(‘E’).

The data field format for the second lamp/relay control message form is:

“L0”{(hhhh}.

The string {hhhh} represents a four digit ASCII Hexadecimal number string. The typical range of this string will be 0(“0000”) to 4095 (“0FFF”). The least significant bit, bit 0, controls lamp/relay 1, and bit 13 controls lamp/relay 14. The remaining bits should be programmed as zero.

Lamp/relays 13 and 14 are typically reserved to control two meters. For this reason, the typical range for this form of the lamp/relay control message value string contains a ‘0’ for the most significant four bits.

The user may use lamp/relay drivers 13 and 14 to drive lamps, relays, or totalizing meters. The firmware does not eliminate drivers 13 and 14 from the range of lamps/relays drivers that can be controlled by this message simply because they are typically used to control totalizing meters. It is the responsibility of the game computer to use the drivers appropriately.

2.1.2. Pulse Meter Message

The pulse meter message allows a lamp/relay driver to be pulsed for a programmed number of times as defined by a four character ASCII Hexadecimal number string. The pulse meter message uses only lamp/relay drivers 13 and 14 to control the two totalizing meters found in most configurations. The pulse meter message definition is:

‘M’{d} {hh}

The ASCII Decimal digit {h} defines which lamp/relay driver will be pulsed. The valid range for {d} is 1(‘1’) to 2(‘2’). Pulses for meter 1 are sent to lamp/relay 13. Those for meter 2 are sent to lamp/relay driver 14. The two digit ASCII Hexadecimal number {hh} represents the number of pulses sent to the addressed lamp/relay driver. The valid range for {hh} is 1(‘1’) to 255 (“FF”)

The pulse meter message causes the addressed board to begin pulsing the selected meter's lamp/relay driver with a pulse train equivalent to five pulses per second. This rate is adequate for most totalizing meters.

The PLAYER and CONCENTRATOR boards accept additional pulse meter messages from the game computer before the previous pulse meter message has been completed. The firmware maintains the meter pulse count for meter in internal 16-bit registers. It is the responsibility of the game computer not to cause an overflow of these meter pulse count registers. The firmware sends a status message to the game computer whenever either pulse meter count register decrements to zero, thus completing the command.

2.1.3. Dispense Ticket Message

The dispense ticket message commands the PLAYER or the CONCENTRATOR boards to dispense a programmable number of tickets as defined by a four character ASCII Hexadecimal number string. The pulse meter message definition is:

‘T’ {hh}

The two digit ASCII Hexadecimal number {hh} represents the number of tickets to be dispensed from the ticket dispenser. The valid range for {hh} is 1(‘1’) to 255(“FF”).

The dispense ticket message causes the addressed board to begin dispensing tickets at the rate of the attached ticket dispenser. The PLAYER and CONCENTRATOR boards accept additional dispense ticket messages from the game computer before the previous dispense ticket message has been completed. The firmware maintains the ticket dispense count in a 16-bit internal register. It is the responsibility of the game computer not to overflow the ticket dispense count register. The firmware sends a status message to the game computer whenever the ticket dispense count register decrements to zero, thus completing the command.

2.1.4. Dispense Tokens Message

The dispense tokens message commands the PLAYER or the CONCENTRATOR board to dispense a programmable number of tokens as defined by a four character ASCII Hexadecimal number string. The pulse meter message definition is:

‘H’{hh}.

The two digit ASCII Hexadecimal number {hh} represent the number of tokens to be dispensed from the token dispenser's hopper. The valid range for {hh} is 1(‘1’) to 255(“FF”).

The dispense token message causes the addressed board to begin dispensing tokens at the rate of the attached token dispenser. The PLAYER and CONCENTRATOR boards accept additional dispense tokens messages from the game computer before the previous dispense tokens message has been completed. The firmware maintains the token dispense count in a 16-bit internal register. It is the responsibility of the game computer not to overflow the token dispense count register. Firmware sends a status message to the game computer whenever the token dispense count register decrements to zero, thus completing the command.

2.1.5. Display Data Message

A numeric display capable of displaying two eight digit numbers, including a decimal point, can be controlled by either the PLAYER or CONCENTRATOR board. The boards automatically determine during board initialization whether an LED display module is connected to the LED display serial port. If an LED display is found, the boards direct the data to the LED display module, otherwise the boards assume that an LCD display module is attached and direct the data to that display. The display data message definition is: ‘D’{d} {NULL-terminated ASCII Decimal numeric string}. The ASCII decimal digit {d} selects into which of the two supported display fields the ASCII decimal numeric string will be displayed. The valid values for {d} is 1(‘1’) or 2(‘2’). Valid characters for the ASCII decimal numeric string elements are ‘0’ to ‘9’ and ‘.’.

The numeric string is displayed as transmitted. It is responsibility of the game computer to transmit a valid numeric string. A maximum of eight characters, excluding the decimal point, may be displayed in each field. If more than eight digits are transmitted, the display is only updated with the first eight characters received.

2.2. CONCENTRATOR-Only Output Messages

There is one output message specific to the CONCENTRATOR board.

2.2.1. Set Baud Rate Message

This message allows the game computer to control the baud rate of all the serial ports installed on the CONCENTRATOR. Each PLAYER board is connected to the CONCENTRATOR using a serial port. These ports have defined baud rates of 9600 baud. Since this message is specific to the CONCENTRATOR, the game computer should not change the baud rate of the serial ports connected to the PLAYER boards.

The printer and the progressive sign are serial devices connected to the CONCENTRATOR. For these devices, the baud rate may vary. Thus, the message is intended to allow the game computer to program the baud rate of the serial ports to which these two devices are connected. Table 3 defines the default configuration and connectivity of the available serial ports.

The format for the set band rate message is:

‘z’{h} {speed code} {‘8’|‘7’} {‘N’|‘E’|‘0’} {‘1’|‘2’}.

The ASCII Hexadecimal digit {h} defines the serial port to be programmed. Table 4 defines the character {speed code} used to define the baud rate for the port to be programmed.

TABLE 3
SERIAL PORT MAP

| Device | Port # | Address | Configuration |
|---|---|---|---|
| PLAYER 1 | 0 | ‘A’ | 9600, 8, N, 1 |
| PLAYER 2 | 1 | ‘B’ | 9600, 8, N, 1 |
| PLAYER 3 | 2 | ‘C’ | 9600, 8, N, 1 |
| PLAYER 4 | 3 | ‘D’ | 9600, 8, N, 1 |
| PLAYER 5 | 4 | ‘E’ | 9600, 8, N, 1 |
| Progressive | 5 | ‘S’ | 2400, 8, N, 1 |
| Printer | 6 | ‘P’ | 9600, 8, N, 1 |
| Spare 1 | 7 | — | 9600, 8, N, 1 |
| Spare 2 | 8 | — | 9600, 8, N, 1 |
| Spare 3 | 9 | — | 9600, 8, N, 1 |
| Spare 4 | 10 | — | 9600, 8, N, 1 |
| Spare 5 | 11 | — | 9600, 8, N, 1 |
| Spare 6 | 12 | — | 9600, 8, N, 1 |
| Spare 7 | 13 | — | 9606, 8, N, 1 |
| Spare 8 | 14 | — | 9600, 8, N, 1 |
| Spare 9 | 15 | — | 9600, 8, N, 1 |

TABLE 4
SERIAL PORT SPEED CODES

| Baud Rate | Speed Code |
|---|---|
| 300 | ‘A’ |
| 600 | ‘B’ |
| 1200 | ‘C’ |
| 2400 | ‘D’ |
| 4800 | ‘E’ |
| 9600 | ‘F’ |
| 19200 | ‘G’ |
| 38400 | ‘H’ |

2.3. Progressive Sign and Printer Output Messages

Messages to the progressive sign or to the printer are formatted according to the general output message format specified in section 1.1. The CONCENTRATOR board simply routes the data field of the general message format to the serial port connected to the addressed device: the progressive sign or the printer. The format of the data field is wholly controlled by the game computer. The CONCENTRATOR does not parse the data field except to find the terminating ASCII NULL. Thus, the data field of the output messages directed to these two devices cannot include ASCII NULLs.

2.4. General Purpose Control Messages

The PLAYER and CONCENTRATOR boards may be controlled completely with the two messages defined in this section. The output messages defined in sections 2.1 and 2.2 are designed to allow the PLAYER/CONCENTRATOR to off-load some of the burden of explicitly controlling or polling each peripheral device function. The two messages defined in this section allow the game computer more explicit control of the various device functions of the PLAYER and CONCENTRATOR boards and to determine the status of the PLAYER and CONCENTRATOR boards.

2.4.1. Read Register Message

The read register message allows the game computer to explicitly read the contents of the internal register being used by the PLAYER/CONCENTRATOR board firmware for various input, control, or status functions. The syntax for this message is:

‘R’{h}.

The ASCII Hexadecimal digit {h} is the address of the internal register to be read. Table 5 defines the register addresses that may be read. Each register defined in Table 5 is an 8-bit register the contents of which are returned to the game computer as a status message.

TABLE 5
READ REGISTER ADDRESSES

| Name | Function | Address |
|---|---|---|
| Digital Input #1 | Push-button Bank 1 | ‘1’ |
| Digital Input #2 | Push-button Bank 2 | ‘2’ |
| Digital Input #3 | General Purpose Inputs | ‘3’ |
| Digital Input #4 | DIP Switches | ‘4’ |
| Digital Input #5 | Meter #1 Count (low) | ‘5’ |
| Digital Input #6 | Meter #1 Count (high) | ‘6’ |
| Digital Input #7 | Meter #2 Count (low) | ‘7’ |
| Digital Input #8 | Meter #2 Count (high) | ‘8’ |
| Digital Input #9 | Token Count (low) | ‘9’ |
| Digital Input #10 | Token Count (high) | ‘A’ |
| Digital Input #11 | Ticket Count (low) | ‘B’ |
| Digital Input #12 | Ticket Count (high) | ‘C’ |
| Status Register | FPGA/Firmware Status | ‘F’ |

2.4.2. Write Register Message

The read register message allows the game computer to explicitly read the contents of the internal register being used by the PLAYER/CONCENTRATOR board firmware for various input, control, or status functions. The syntax from this message is:

‘W’{h} {hh}.

The ASCII Hexadecimal digit {h} is the address of the internal register to be read. The two ASCII Hexadecimal digit {hh} defines the data to be written to the selected internal register. Table 6 defines the register addresses that may be read. Each register defined in Table 6 is an 8-bit register the contents of which will be modified to the value contained in the write register message.

TABLE 6
WRITE REGISTER ADDRESSES

| Name | Function | Address |
|---|---|---|
| Digital Output #1 | Lamp Bank 1 | ‘1’ |
| Digital Output #2 | Lamp Bank 2 | ‘2’ |
| Digital Output #3 | General Purpose Outputs | ‘3’ |
| Digital Output #4 | General Purpose Outputs | ‘4’ |
| Digital Output #5 | Meter #1 Count (low) | ‘5’ |
| Digital Output #6 | Meter #1 Count (high) | ‘6’ |
| Digital Output #7 | Meter #2 Count (low) | ‘7’ |
| Digital Output #8 | Meter #2 Count (high) | ‘8’ |
| Digital Output #9 | Token Count (low) | ‘9’ |
| Digital Output #10 | Token Count (high) | ‘A’ |
| Digital Output #11 | Ticket Count (low) | ‘B’ |
| Digital Output #12 | Ticket Count (high) | ‘C’ |
| Control Register | FPGA/Firmware Control | ‘F’ |

3. Input Messages: PLAYER/CONCENTRATOR

Section 2 defined the output messages from the game computer to either the PLAYER or the CONCENTRATOR board. This section defines the messages from the PLAYER and CONCENTRATOR boards to the game computer. The input messages to the game computer are presently classified into four types: error, status, credit action, and push-button action. These messages are sent by the PLAYER board through the serial port to the CONCENTRATOR board's keyboard port to the game computer. While the CONCENTRATOR board also sends these messages to the game computer, it does so only through the keyboard connector. The CONCENTRATOR board translates all input messages into keyboard keycode sequences.

This section defines the input messages from the PLAYER/CONCENTRATOR as ASCII sequences. There are input messages common to both the PLAYER and CONCENTRATOR boards as well as messages that originate only from the CONCENTRATOR board. The common input messages are defined in subsection 3.1. The CONCENTRATOR-specific input messages are defined in subsection 3.2. The translation of the ASCII input messages into keyboard keycode sequences are defined in section 4.

3.1. Common Input Messages

This subsection defines the common input messages for the PLAYER and the CONCENTRATOR boards. The four input message types follow the same basic format as defined in subsection 1.2. Refer to Table 1 and to Table 2 for the address and type identifiers.

3.1.1. Common Error Input Messages

The error input message definition is:

‘?’{a} {hh}.

The ASCII character {a} defines the address of the source as defined in Table 1. The two character ASCII Hexadecimal number {hh} identifies the error code. The currently defined error codes are provided in Table 7.

TABLE 7
COMMON ERROR CODES

| Detected Error | Code |
|---|---|
| FPGA Reloaded/Power-Off Intrusion | “80” |
| Token Hopper Overflow | “40” |
| Token Hopper Empty | “20” |
| Ticket Dispenser Empty | “10” |

3.1.2. Common Status Input Messages

There are two kind of status input messages: solicited and unsolicited. Solicited status input messages are sent to the game computer as a result of a direct request. Direct requests for status input messages are made using the read register output message.

Unsolicited status input messages are sent to the game computer as a result of the error free completion of an action initiated by an output message. For example, unsolicited status input messages are returned by the pulse meter, the dispense ticket, and the dispense token output messages whenever the appropriate count register decrements to zero.

The status input message format is:

‘!’{a} {h} {hh}.

The ASCII character {a} is the address of the source as defined by Table 1. The single ASCII Hexadecimal digit {h} is the read register codes for the two ASCII Hexadecimal digit {hh} data which follows. The read register codes are given in Table 5. The read register “F” is used to identify unsolicited status input messages. Table 8 defines the four unsolicited status input message data fields currently defined.

TABLE 8
UNSOLICITED STATUS RESPONSE CODES

| Status Indication | Status Code |
|---|---|
| Token Dispensing Complete | “08” |
| Ticket Dispensing Complete | “04” |
| Meter #2 Count Complete | “02” |
| Meter #1 Count Complete | “01” |

3.1.3. Common Credit Action Input Message

The PLAYER and CONCENTRATOR boards are designed to accept both a serial output dollar bill acceptor (DBA), or a pulsed output DBA. The credit action message is defined to efficiently notify the game computer of the credit code received from a serial output DBA. Neither the PLAYER board or the CONCENTRATOR board interpret the credit code received. It is the responsibility of the game computer to process the credit action input message and to send a pulse meter output message to the appropriate board in order to record the appropriate number of credits on a totalizing meter.

The credit action input message format is:

‘$’{a} {hh}.

The ASCII character {a} is the address of the source as defined in Table 1. The two digit ASCII Hexadecimal number {hh} is the code sent by the DBA.

No interpretation of that code is performed by the PLAYER firmware or the CONCENTRATOR firmware with respect to the value of the currency accepted by the DBA. The PLAYER/CONCENTRATOR does process the control/status codes received from the DBA in order the maintain control of the DBA. The range of values that the game computer should expect for the DBA credit action input message data filed is 129(“81”) to 133(“85”). Table 9 defines the complete set of values that the PLAYER or CONCENTRATOR expects to receive from the DBA. The values provided represent the definition for CashCode-compatible serial output DBAs. The DBA message codes defined in Table 9 also include several error codes, beginning with “failure detected.” These error codes are reported using the credit action input message rather than the error input message.

TABLE 9
CREDIT ACTION INPUT MESSAGE CODES

| DBA Message | Hex Code |
|---|---|
| $1 Credit | “81” |
| $2 Credit | “82” |
| $5 Credit | “83” |
| $10 Credit | “84” |
| $20 Credit | “85” |
| reserved | “86” |
| reserved | “87” |
| Vend | “89” |
| Bill Returned | “8A” |
| Bill Rejected | “8B” |
| Failure Detected | “8C” |
| Stacker Full | “8D” |
| Lockable Cassette Removed | “8E” |
| Lockable Cassette Attached | “8F” |

3.1.4. Common Push-button Action Input Messages

The PLAYER and CONCENTRATOR boards implement digital input switch debouncing on the first 16 digital inputs. These inputs are thus treated as push-buttons. The firmware debounces the closing or opening of external switches. Only fully debounced changes of state are sent as push-button input messages to the game computer. The firmware also prevents the simultaneous closure of two or more switches. This does not mean that the game computer cannot implement multi-button logic, but it does require that the game computer use the more general purpose read register output message to read the sate of multiple switches simultaneously. The firmware reports the closing of a push-button using a lower case alphabetic ASCII character, and it reports the opening of the switch as an upper case alphabetic character. Each push-button, PB1 through PB16 is reported as ‘A’ through ‘P’ or ‘a’ through ‘p’, depending on whether the push-button is being opened or closed, respectively. The format for this input message type is:

‘@’{a} {‘A’ . . ‘P’|‘a’ . . ‘P’}.

The ASCII character {a} defines the source of the push-button action input menages as defined by Table 1.

3.2. CONCENTRATOR-specific Input Messages

The preceding subsection defined the common input messages for the PLAYER and CONCENTRATOR boards. At this time there are no CONCENTRATOR-specific input messages defined.

4. ASCII Messages Keycode Translation

A primary difference between the message translation of the CONCENTRATOR board firmware and that of the PLAYER firmware is that the CONCENTRATOR board firmware translates all messages to be sent to the game computer into IBM PC/AT-compatible keyboard keycode sequences. It also sends all input messages to the game computer via the game computer's keyboard port. This section defines a keycode translation. table for all the ASCII input messages.

4.1. Push-button Keyboard Scan Code Translation Matrix

Table 10 defines the translation of the push-button action input messages into keycodes compatible with the game system. In the table, N0-N9 represent the ten keycodes for the keyboard's number pad; F1-F6 represent the function keys; and keycodes preceded with a lower case S indicate that the keycode is preceded with the keycode with the left shift button.

TABLE 10
PUSH-BUTTON KEYCODE TRANSLATION TABLE

| PB# | ASCII Code | PS#1 | PS#2 | PS#3 | PS#4 | PS#5 | CONC |
|---|---|---|---|---|---|---|---|
| 1 | ‘A’,‘a’ | N0 | 0 | A | I | Q | Pause |
| 2 | ‘B’,‘b’ | N7 | 7 | H | P | X | N9 |
| 3 | ‘C’,‘c’ | N5 | 5 | F | N | V | Enter |
| 4 | ‘D’,‘d’ | N1 | 1 | B | J | R | ESC |
| 5 | ‘E’,‘e’ | N2 | 2 | C | K | S | TAB |
| 6 | ‘F’,‘f’ | N6 | 6 | G | O | W | / |
| 7 | ‘G’,‘g’ | N8 | 8 | Space | Y | Z | Scroll |
| | | | | | | | Lock |
| 8 | ‘H’,‘h’ | N3 | 3 | D | L | T | Num Lock |
| 9 | ‘I’,‘i’ | N4 | 4 | E | M | U | Caps Lock |
| 10 | ‘J’,‘j’ | F1 | F2 | F3 | F4 | F5 | F6 |
| 11 | ‘K’,‘k’ | sA | sG | sM | sS | sY | BS |
| 12 | ‘L’,‘l’ | sB | sH | sN | sT | sZ | Del |
| 13 | ‘M’,‘m’ | sC | sI | sO | sU | s0 | Ins |
| 14 | ‘N’,‘n’ | sD | sJ | sP | sV | s3 | Home |
| 15 | ‘O’,‘o’ | sE | sK | sQ | sW | s6 | End |
| 16 | ‘P’,‘p’ | sF | sL | sR | sX | s9 | NEnter |

The keycode scan code require the CONCENTRATOR firmware to generate both make and break sequences during the translation process. Thus, Tables 11 through 16 provide scan code sequences for each of five player stations and the CONCENTRATOR to document the keyboard scancode sequence required in the translation tables for the push-button action input messages.

TABLE 11
PLAYER STATION #1 SCAN CODE SEQUENCES

| | Make | | | |
|---|---|---|---|---|
| PB# | Code | Make Sequence | Break Code | Break Sequence |
| 1 | ‘a’ | 0×70 | ‘A’ | 0×F0, 0×70 |
| 2 | ‘b’ | 0×6C | ‘B’ | 0×F0, 0×6C |
| 3 | ‘c’ | 0×73 | ‘C’ | 0×F0, 0×73 |
| 4 | ‘d’ | 0×69 | ‘D’ | 0×F0, 0×69 |
| 5 | ‘e’ | 0×72 | ‘E’ | 0×F0, 0×72 |
| 6 | ‘f’ | 0×74 | ‘F’ | 0×F0, 0×74 |
| 7 | ‘g’ | 0×75 | ‘G’ | 0×F0, 0×75 |
| 8 | ‘h’ | 0×7A | ‘H’ | 0×F0, 0×7A |
| 9 | ‘i’ | 0×6B | ‘I’ | 0×F0, 0×6B |
| 10 | ‘j’ | 0×05 | ‘J’ | 0×FQ, 0×05 |
| 11 | ‘k’ | 0×12, 0×16 | ‘K’ | 0×F0, 0×16, 0×F0, 0×12 |
| 12 | ‘l’ | 0×12, 0×32 | ‘L’ | 0×F0, 0×32, 0×F0, 0×12 |
| 13 | ‘m’ | 0×12, 0×21 | ‘M’ | 0×F0, 0×21, 0×F0, 0×12 |
| 14 | ‘n’ | 0×12, 0×23 | ‘N’ | 0×F0, 0×23, 0×F0, 0×12 |
| 15 | ‘o’ | 0×12, 0×24 | ‘O’ | 0×F0, 0×24, 0×F0, 0×12 |
| 16 | ‘p’ | 0×12, 0×2B | ‘P’ | 0×F0, 0×2B, 0×F0, 0×12 |

TABLE 12
PLAYER STATION #2 SCAN CODE SEQUENCES

| | Make | | | |
|---|---|---|---|---|
| PB# | Code | Make Sequence | Break Code | Break Sequence |
| 1 | ‘a’ | 0×45 | ‘A’ | 0×F0, 0×45 |
| 2 | ‘b’ | 0×3D | ‘B’ | 0×F0, 0×3D |
| 3 | ‘c’ | 0×2E | ‘C’ | 0×F0, 0×2E |
| 4 | ‘d’ | 0×16 | ‘D’ | 0×F0, 0×16 |
| 5 | ‘e’ | 0×1E | ‘E’ | 0×F0, 0×1E |
| 6 | ‘f’ | 0×36 | ‘F’ | 0×F0, 0×36 |
| 7 | ‘g’ | 0×3E | ‘G’ | 0×F0, 0×3E |
| 8 | ‘h’ | 0×26 | ‘H’ | 0×F0, 0×26 |
| 9 | ‘i’ | 0×25 | ‘I’ | 0×F0, 0×25 |
| 10 | ‘j’ | 0×06 | ‘J’ | 0×F0, 0×06 |
| 11 | ‘k’ | 0×12, 0×34 | ‘K’ | 0×F0, 0×34, 0×F0, 0×12 |
| 12 | ‘l’ | 0×12, 0×33 | ‘L’ | 0×F0, 0×33, 0×F0, 0×12 |
| 13 | ‘m’ | 0×12, 0×43 | ‘M’ | 0×F0, 0×43, 0×F0, 0×12 |
| 14 | ‘n’ | 0×12, 0×3B | ‘N’ | 0×F0, 0×3B, 0×F0, 0×12 |
| 15 | ‘o’ | 0×12, 0×42 | ‘O’ | 0×F0, 0×42, 0×F0, 0×12 |
| 16 | ‘p’ | 0×12, 0×4B | ‘P’ | 0×F0, 0×4B, 0×F0, 0×12 |

TABLE 13
PLAYER STATION #3 SCAN CODE SEQUENCES

| | Make | | | |
|---|---|---|---|---|
| PB# | Code | Make Sequence | Break Code | Break Sequence |
| 1 | ‘a’ | 0×16 | ‘A’ | 0×F0, 0×16 |
| 2 | ‘b’ | 0×33 | ’B’ | 0×F0, 0×33 |
| 3 | ‘c’ | 0×2B | ’C’ | 0×F0, 0×2B |
| 4 | ‘d’ | 0×32 | ’D’ | 0×F0, 0×32 |
| 5 | ‘e’ | 0×21 | ’E’ | 0×F0, 0×21 |
| 6 | ‘f’ | 0×34 | ’F’ | 0×F0, 0×34 |
| 7 | ‘g’ | 0×29 | ’G’ | 0×F0, 0×29 |
| 8 | ‘h’ | 0×23 | ’H’ | 0×F0, 0×23 |
| 9 | ‘i’ | 0×24 | ’I’ | 0×F0, 0×24 |
| 10 | ‘j’ | 0×04 | ’J’ | 0×F0, 0×04 |
| 11 | ‘k’ | 0×12, 0×3A | ’K’ | 0×F0, 0×3A, 0×F0, 0×12 |
| 12 | ‘l’ | 0×12, 0×31 | ’L’ | 0×F0, 0×31, 0×F0, 0×12 |
| 13 | ‘m’ | 0×12, 0×44 | ’M’ | 0×F0, 0×44, 0×F0, 0×12 |
| 14 | ‘n’ | 0×12, 0×4D | ’N’ | 0×F0, 0×4D, 0×F0, 0×12 |
| 15 | ‘o’ | 0×12, 0×15 | ’O’ | 0×F0, 0×15, 0×F0, 0×12 |
| 16 | ‘p’ | 0×12, 0×2D | ’P’ | 0×F0, 0×2D, 0×F0, 0×12 |

TABLE 14
PLAYER STATION #4 SCAN CODE SEQUENCES

| | Make | | | |
|---|---|---|---|---|
| PB# | Code | Make Sequence | Break Code | Break Sequence |
| 1 | ‘a’ | 0×15 | ‘A’ | 0×F0, 0×15 |
| 2 | ‘b’ | 0×22 | ‘B’ | 0×F0, 0×22 |
| 3 | ‘c’ | 0×2A | ‘C’ | 0×F0, 0×2A |
| 4 | ‘d’ | Q×2D | ‘D’ | 0×F0, 0×2D |
| 5 | ‘e’ | 0×1B | ‘E’ | 0×F0, 0×1B |
| 6 | ‘f’ | 0×1D | ‘F’ | 0×F0, 0×1D |
| 7 | ‘g’ | 0×1A | ‘G’ | 0×F0, 0×1A |
| 8 | ‘h’ | 0×26 | ‘H’ | 0×F0, 0×26 |
| 9 | ‘i’ | 0×3C | ‘I’ | 0×F0, 0×3C |
| 10 | ‘j’ | 0×03 | ‘J’ | 0×F0, 0×03 |
| 11 | ‘k’ | 0×12, 0×35 | ‘K’ | 0×F0, 0×35, 0×F0, 0×12 |
| 12 | ‘l’ | 0×12, 0×1A | ‘L’ | 0×F0, 0×1A, 0×F0, 0×12 |
| 13 | ‘m’ | 0×12, 0×45 | ‘M’ | 0×F0, 0×45, 0×F0, 0×12 |
| 14 | ‘n’ | 0×12, 0×26 | ‘N’ | 0×F0, 0×26, 0×F0, 0×12 |
| 15 | ‘o’ | 0×12, 0×36 | ‘O’ | 0×F0, 0×36, 0×F0, 0×12 |
| 16 | ‘p’ | 0×12, 0×46 | ‘P’ | 0×F0, 0×46, 0×F0, 0×12 |

TABLE 15
PLAYER STATION #5 SCAN CODE SEQUENCES

| | Make | | | |
|---|---|---|---|---|
| PB# | Code | Make Sequence | Break Code | Break Sequence |
| 1 | ‘a’ | 0×43 | ‘A’ | 0×F0, 0×43 |
| 2 | ‘b’ | 0×4D | ‘B’ | 0×F0, 0×4D |
| 3 | ‘c’ | 0×31 | ‘C’ | 0×F0, 0×31 |
| 4 | ‘d’ | 0×3B | ‘D’ | 0×F0, 0×3B |
| 5 | ‘e’ | 0×42 | ‘E’ | 0×F0, 0×42 |
| 6 | ‘f’ | 0×44 | ‘F’ | 0×F0, 0×44 |
| 7 | ‘g’ | 0×35 | ‘G’ | 0×F0, 0×35 |
| 8 | ‘h’ | 0×4B | ‘H’ | 0×F0, 0×4B |
| 9 | ‘i’ | 0×3A | ‘I’ | 0×F0, 0×3A |
| 10 | ‘j’ | 0×0C | ‘J’ | 0×F0, 0×0C |
| 11 | ‘k’ | 0×12, 0×1B | ‘K’ | 0×F0, 0×1B, 0×F0, 0×12 |
| 12 | ‘l’ | 0×12, 0×26 | ‘L’ | 0×F0, 0×26, 0×F0, 0×12 |
| 13 | ‘m’ | 0×12, 0×3C | ‘M’ | 0×F0, 0×3C, 0×F0, 0×12 |
| 14 | ‘n’ | 0×12, 0×2A | ‘N’ | 0×F0, 0×2A, 0×F0, 0×12 |
| 15 | ‘o’ | 0×12, 0×1D | ‘O’ | 0×F0, 0×1D, 0×F0, 0×12 |
| 16 | ‘p’ | 0×12, 0×22 | ‘P’ | 0×F0, 0×22, 0×F0, 0×12 |

TABLE 16
CONCENTRATOR SCAN CODE SEQUENCES

| | Make | | | |
|---|---|---|---|---|
| PB# | Code | Make Sequence | Break Code | Break Sequence |
| 1 | ‘a’ | 0×E1, 0×14, | ‘A’ | none |
| | | 0×77, 0×E1, | | |
| | | 0×F0, 0×14, | | |
| | | 0×F0, 0×77 | | |
| 2 | ‘b’ | 0×7D | ‘B’ | 0×F0, 0×7D |
| 3 | ‘c’ | 0×5A | ‘C’ | 0×F0, 0×5A |
| 4 | ‘d’ | 0×76 | ‘D’ | 0×F0, 0×76 |
| 5 | ‘e’ | 0×0D | ‘E’ | 0×F0, 0×0D |
| 6 | ‘f’ | 0×4A | ‘F’ | 0×F0, 0×4A |
| 7 | ‘g’ | 0×7E | ‘G’ | 0×F0, 0×7E |
| 8 | ‘h’ | 0×77 | ‘H’ | 0×F0, 0×77 |
| 9 | ‘i’ | 0×58 | ‘I’ | 0×F0, 0×58 |
| 10 | ‘j’ | 0×0B | ‘J’ | 0×F0, 0×0B |
| 11 | ‘k’ | 0×56 | ‘K’ | 0×F0, 0×56 |
| 12 | ‘l’ | 0×E0, 0×71 | ‘L’ | 0×E0, 0×F0, 0×71 |
| 13 | ‘m’ | 0×E0, 0×70 | ‘M’ | 0×E0, 0×F0, 0×70 |
| 14 | ‘n’ | 0×E0, 0×6C | ‘N’ | 0×E0, 0×F0, 0×6C |
| 15 | ‘o’ | 0×E0, 0×69 | ‘O’ | 0×E0, 0×F0, 0×69 |
| 16 | ‘p’ | 0×E0, 0×5A | ‘P’ | 0×E0, 0×F0, 0×5A |

4.2. Error, Status, and Credit Action Scan Code Translation

These input message types follow a prescribed message format defined above in section 3. This section defines the scan code sequences for these messages by first defining the scan code alphabet the message types must use. An alphabet of scan codes can be defined because these message types use only a finite number of ASCII codes to form each input message. The ASCII character alphabet for these messages is:

{‘?’,‘!’,‘$’,‘@’,‘0’ . . ‘9’,‘A’ . . ‘F’,‘P’,‘S’}.

Table 17 defines the make and break scan code sequences for these message types.

TABLE 17
SCAN CODES FOR ERROR, STATUS, AND CREDIT ACTION
MESSAGES

| ASCII | Make | Break |
|---|---|---|
| ‘?’ | 0×03 | 0×F0, 0×03 |
| ‘!’ | 0×0C | 0×F0, 0×0C |
| ‘$’ | 0×04 | 0×F0, 0×04,0×F0, 0×12 |
| ‘A’ | 0×16 | 0×F0, 0×16 |
| ‘B’ | 0×32 | 0×F0, 0×32 |
| ‘C’ | 0×21 | 0×F0, 0×21 |
| ‘D’ | 0×23 | 0×F0, 0×23 |
| ‘E’ | 0×24 | 0×F0, 0×24 |
| ‘F’ | 0×2B | 0×F0, 0×2B |
| ‘P’ | 0×4D | 0×F0, 0×4D |
| ‘S’ | 0×1B | 0×F0, 0×1B |
| ‘0’ | 0×45 | 0×F0, 0×45 |
| ‘1’ | 0×16 | 0×F0, 0×16 |
| ‘2’ | 0×1E | 0×F0, 0×1E |
| ‘3’ | 0×26 | 0×F0, 0×26 |
| ‘4’ | 0×25 | 0×F0, 0×25 |
| ‘5’ | 0×2E | 0×F0, 0×2E |
| ‘6’ | 0×36 | 0×F0, 0×36 |
| ‘7’ | 0×3D | 0×F0, 0×3D |
| ‘8’ | 0×3E | 0×F0, 0×3E |
| ‘9’ | 0×46 | 0×F0, 0×46 |
| ‘@’ | 0×06 | 0×F0, 0×06 |

As an example, the Token Hopper overflow Error input message from player station 1 may be written as

“?A80”.

That message would consist of the following scan code sequence: 0x03, 0xF0, 0x03, 0x16, 0xF0, 0x16, 0x3E, 0xF0, 0x3E,0x45, 0xF0, 0x45.

As the above scan code sequence indicates, each “key stroke” constists of the make scan code immediately followed by the break scan code for the same key. An exception is that the break scan code for the left shift key follows the break scan code for the key being shifted.

What is claimed is:

1. A video gaming system which includes a computer assembly which executes an event driven gaming program, at least one player station for outputting player input messages to the computer assembly, and an assembly for metering information relating to at least one of the following: game activities; and activity relating to the computer assembly, where said activity is selected from one of the following:
(a) opening or closing of a door which provides access to a cabinet which houses at least part of the said computer assembly,
(b) operations of input devices at each said at least one player station, and
(c) operations of output devices at each said at least one player station.

2. A system according to claim 1 wherein said input devices are buttons.

3. A system according to claim 1 wherein said output devices are lamps.

4. A system according to claim 1 wherein said output devices are redeemable ticket dispensers.

5. A system according to claim 1 wherein said input devices include electronic currency acceptance means.

6. A system according to claim 1 wherein said output devices include electronic currency output means.

7. A system according to claim 1 wherein said gaming program is a card gaming program.

8. A system according to claim 1 wherein said gaming program is a card gaming program playing the game blackjack.

9. A system according to claim 1 wherein said gaming program is a card gaming program playing the game poker.

10. A multiplayer gaming system, which includes a computer assembly which executes an event driven gaming program, more than one player station for outputting player input messages to the computer assembly, a single display means for displaying game activity of said gaming program, and an assembly for metering information relating to at least one of the following: game activities; and activity relating to the computer assembly, where said activity is selected from one of the following:
(a) opening or closing of a door which provides access to a cabinet which houses at least part of the said computer assembly;
(b) operations of input devices at each said at least one player station; and
(c) operations of output devices at each said at least one player station.

11. A system according to claim 10 wherein said input devices are buttons.

12. A system according to claim 10 wherein said output devices are lamps.

13. A system according to claim 10 wherein said output devices are redeemable ticket dispensers.

14. A system according to claim 10 wherein said input devices include electronic currency acceptance means.

15. A system according to claim 10 wherein said output devices include electronic currency output means.

16. A system according to claim 10 wherein said output device is a single printer for printing redeemable tickets for all players.

17. A system according to claim 10 wherein said gaming program is a card gaming program.

18. A system according to claim 10 wherein said gaming program is a card gaming program playing the game of blackjack.

19. A system according to claim 10 wherein said gaming program is a card gaming program playing the game of poker.

20. A video gaming player station device which includes, a local processor for encoding and decoding messages, a communication means with one or more input devices, a communication means with one or more output devices, and a communication means with a computer assembly which executes an event driven gaming program.

21. A device according to claim 20 wherein said input devices are buttons.

22. A device according to claim 20 wherein said output devices are lamps.

23. A device according to claim 20 wherein said output devices are redeemable ticket dispensers.

24. A device according to claim 20 wherein said input devices include electronic currency acceptance means.

25. A device according to claim 20 wherein said output devices include electronic currency output means.

26. A device according to claim 20 wherein said gaming program executes responsively to messages output from player station device and received by said computer assembly.

27. A device according to claim 20 wherein said gaming program outputs messages to said player station device, and said messages affect the state of said output devices.

28. A device according to claim 20 wherein said gaming program is a card gaming program.

29. A device according to claim 20 wherein said gaming program is a multiplayer card gaming program.

30. A device according to claim 20 wherein communication means with said computer assembly includes a message with address identifier related to said player station transmitting said message.

31. A device according to claim 20 wherein player station receipt of a message from said computer assembly effects state of said connected output devices.

32. A device according to claim 20 wherein said player station device has a selectable address identification means.

33. A device according to claim 20 wherein said gaming program transmits said message including message address identifier enabling delivery of said message to said player station with corresponding address.

34. A gaming system which includes an event driven video gaming program, in operative communication with at least one player station device, processing means at said player station device for encoding and decoding messages, one or more input devices in operative communication with said player station device, one or more output devices in operative communication with said player station device, a unique address identifier means at said player station; whereby said video gaming program is in operative communication with a metering assembly, said metering assembly for metering information relating to at least one of the following: game activities; and activity relating to the computer assembly, where said activity is selected from one of the following:
(a) opening or closing of a door which provides access to a cabinet which houses at least part of the said computer assembly;
(b) operations of input devices at each said at least one player station; and
(c) operations of output devices at each said at least one player station.

35. A system according to claim 34, wherein said metering assembly includes electromechanical metering means.

36. A system according to claim 34, wherein said metering assembly includes software metering means.

37. A system according to claim 34, wherein said program has logic means to ignore certain input messages sent from input means via said player station message

38. A system according to claim 34 wherein said gaming program executes responsively to messages output from player station device and received by said computer assembly.

39. A system according to claim 34 wherein said gaming program outputs messages to said player station device, said output messages affecting the state of said output devices.

40. A system according to claim 38 wherein said gaming program displays game activity upon a common monitor viewable from all participating player stations.

41. A system according to claim 38 wherein said displays game activity related to all player station communications upon a common monitor for all communicating player stations devices.

42. A system according to claim 38 wherein said program receives output messages from more than one player station device.

43. A system according to claim 38 wherein said computer assembly is in operative communication with a remote computer assembly.
